(19) United States
(12) Patent Application Publication
(10) Pub. No.: US 2004/0243825 A1
(43) Pub. Date: Dec. 2, 2004

(54) Netsafe computer security switch

(75) Inventor: Brian J. Hunt, Arlington, VA (US)

Correspondence Address: Brian J. Hunt, 1111 Army-Navy #715, Arlington, VA, 22202, US

(73) Assignee: Computer Hardware

(21) Appl. No.: 10/448,618

(22) Filed: May 31, 2003

(51) Int. Cl. H04L 9/00

(52) U.S. Cl. 713/200

(57) ABSTRACT

The NetSafe Computer Security Switch uses a simple physical switching technology in a way that allows a computer or group of computers to quickly and easily block a communications signal from entering the computer(s) and restart the signal without any software and without the need to power down, reboot, or run software on the computer(s).

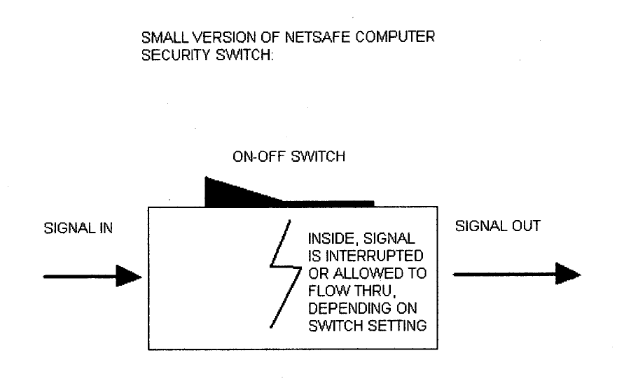

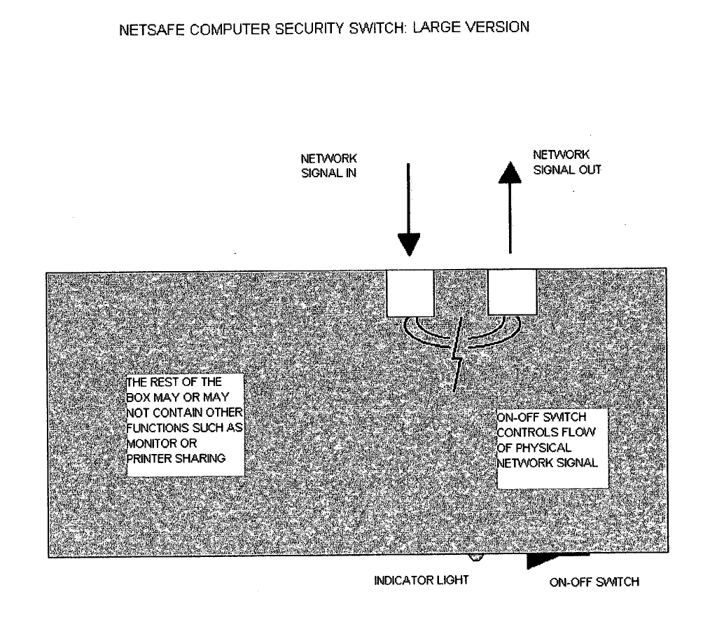

### CROSS-REFERENCE TO RELATED APPLICATIONS

None

### STATEMENT REGARDING FEDERALLY SPONSORED R&D

No government funds, Federal or otherwise, were used for Research and Development of the product described in this application.

### BACKGROUND OF THE INVENTION

This product was conceived and designed solely by the inventor/applicant in response to a need for a simple and effective computer security product. Computers are frequently on a 24/7 Internet, network, or intranet (“network”) connection even though the user does not require a 24/7 connection. Computer users need a simple way to prevent break-ins when they are not using the network. Firewalls and similar software programs help, but are complex, and not easy to configure or keep up to date. Physical disconnection of the network card and/or powering down the computer is inconvenient. This new NetSafe Switch allows the user to temporarily, quickly and easily prevent unwanted network access and quickly restore network access when desired.

### BRIEF DESCRIPTION

A simple to use switch that physically secures a computer from unwanted access via the Internet or other network or workgroup. Other methods of securing a computer from unwanted Internet or network access require a clumsy, time consuming disconnection or the installation and/or configuration of software. This product applies a simple switching system to create an easy to use computer security product.

### DETAILED DESCRIPTION

A simple to use switch with a new application and configuration that can stop any type of network signal from physically reaching a computer, router, access point or other device that uses a network input. The network signal is routed through the switch, and the user may allow signal throughput by leaving the switch in the “on” position, or may block the signal by switching to the “off” position. When the switch is in the off position, the network signal is physically blocked from flowing through the switch and reaching the protected device.

The switch input and output plugs/cables/connectors can take many forms including RJ-45 and RJ-11, as long as the signal is from a network or workgroup, such as that from the Internet, phone company, LAN, WAN or intranet. The input and output would normally be the exact same type of cable on each end, and thus can easily be retrofitted to existing cable schemes by simply patching in to the existing cable.

The switch itself can take several forms, as long as it is easy to use, and makes the “on” or “off” status obvious to the user if they desire. The small version of the switch is only a few centimeters long, and has a network input on each end, with a switch in the middle that allows the user to toggle between “on” and “off”. This switch can sit on a desk, or be mounted under a counter, shelf, etc . . . for easy access by the user. The only indicator on this small version is the obvious position of the switch. A large version sits on a desk or workstation, and may sit under a computer monitor and may be part of a box with other functions. The input and output are in the back of the box and a switch and (if desired by the user) an indicator light will show whether the network connection is on or off.

The switch can be used to physically control the network connection of a single computer, or a group of computers. The switch can be used for a computer, router, modem or access point. The switch is a physical interruption of a network signal; it differs from existing software and firmware products such as firewalls by creating a physical break instead of a logical break.

The functioning of the on-off switch part of the NetSafe Computer Security Switch itself is non-proprietary; the unique aspect of this device is that the physical flow of the network is controlled without the need to turn off any computer device or engage in disconnecting a device, card or connection in an inconvenient and clumsy fashion. Without this device, computers need to be powered down, or complex software is needed to block unwanted network intrusion. With this device, a user can quickly and easily protect their computer from intrusion without software and without the need to power down the computer, server and/or modem, router or access point.

In a wireless environment, such as 802.11b or similar, the NetSecure switch product can be used to secure the hard line as it enters the point of wireless transmission.

1. The aspect of this invention to which I claim enforceable rights is the application of a simple physical switching technology in a way that allows a computer or group of computers to quickly and easily block a communications signal from entering the computer(s) and restart the signal without any software and without the need to power down, reboot, or run software on the computer(s).
